(19) United States
(12) Patent Application Publication
(10) Pub. No.: US 2021/0393376 A1
(43) Pub. Date: Dec. 23, 2021

(54) ATTACHMENTS FOR TOOTH MOVEMENTS

(71) Applicant: uLab Systems, Inc., San Mateo, CA (US)

(72) Inventors: Eric WU, Palo Alto, CA (US); Louis SCHUELLER, Redwood City, CA (US); Surya SARVA, Fremont, CA (US); Henry CAO, San Jose, CA (US)

(73) Assignee: uLab Systems, Inc., San Mateo, CA (US)

(21) Appl. No.: 17/462,198

(22) Filed: Aug. 31, 2021

Related U.S. Application Data
(63) Continuation of application No. PCT/US2020/030523, filed on Apr. 29, 2020.
(60) Provisional application No. 62/840,571, filed on Apr. 30, 2019.

(51) Int. Cl. A61C 7/08; A61C 7/00; A61C 13/34

(52) U.S. Cl. CPC A61C 7/08; A61C 13/34; A61C 7/002

(57) ABSTRACT

Attachments for tooth movements are described herein where the orthodontic attachments may be formed by obtaining a digital model of a dentition of a subject and digitally placing one or more attachments upon the digital model for imparting one or more preselected movements to the dentition. A finite element model may be formed with one or more forces applied to the dentition and an initial stress map may be created to impart upon the dentition based on the finite element model. A subsequent stress map may be predicted using, e.g., machine learning, to achieve the one or more preselected movements.

### CROSS-REFERENCE TO RELATED APPLICATIONS

This application is a continuation of PCT/US2020/030523 filed on Apr. 29, 2020 which claims the benefit of priority to U.S. Prov. 62/840,571 filed Apr. 30, 2019, and which is incorporated herein by reference in its entirety.

### FIELD OF THE INVENTION

The present invention relates to methods and apparatus for orthodontics. More particularly, the present invention relates to methods and apparatus for the creation and positioning of orthodontic attachments upon teeth to facilitate the correction of malocclusions.

### BACKGROUND OF THE INVENTION

Orthodontics is a specialty of dentistry that is concerned with the study and treatment of malocclusions which can result from tooth irregularities, disproportionate facial skeleton relationships, or both. Orthodontics treats malocclusion through the displacement of teeth via bony remodeling and control and modification of facial growth.

This process has been traditionally accomplished by using static mechanical force to induce bone remodeling, thereby enabling teeth to move. In this approach, braces having an archwire interface with brackets are affixed to each tooth. As the teeth respond to the pressure applied via the archwire by shifting their positions, the wires are again tightened to apply additional pressure. This widely accepted approach to treating malocclusions takes about twenty-four months on average to complete, and is used to treat a number of different classifications of clinical malocclusion. Treatment with braces is complicated by the fact that it is uncomfortable and/or painful for patients, and the orthodontic appliances are perceived as unaesthetic, all of which creates considerable resistance to use. Further, the treatment time cannot be shortened by increasing the force, because too high a force results in root resorption, as well as being more painful. The average treatment time of twenty-four months is very long, and further reduces usage. In fact, some estimates provide that less than half of the patients who could benefit from such treatment elect to pursue orthodontics.

Kesling introduced the tooth positioning appliance in 1945 as a method of refining the final stage of orthodontic finishing after removal of the braces (debonding). The positioner was a one-piece pliable rubber appliance fabricated on the idealized wax set-ups for patients whose basic treatment was complete. Kesling also predicted that certain major tooth movements could also be accomplished with a series of positioners fabricated from sequential tooth movements on the set-up as the treatment progressed. However, this idea did not become practical until the advent of three-dimensional (3D) scanning and use of computers by companies including Align Technologies and as well as OrthoClear, ClearAligner, and ClearCorrect to provide greatly improved aesthetics since the devices are transparent.

However, these aligners may not be suitable or they may be inadequate to correct many different types of malocclusions. Different types of attachments may be used with aligners to facilitate the movement of particular teeth. The attachments may be bonded upon the surface of a crown and they may be shaped in various configurations and positioned in different orientations depending upon the movement to be imparted to the tooth.

However, there is some uncertainty in how the attachment should be configured to optimally move a tooth. Accordingly, there exists a need for efficiently and effectively forming and selecting an attachment which facilitates movements of one or more teeth.

### SUMMARY OF THE INVENTION

In many clear aligner cases, attachments may be used to increase the contact areas on one or more of the tooth crowns to augment the grip of an aligner upon the teeth of a patient. The shape and mechanics of the attachments that imparts the force and torque to the teeth, and the software algorithms that place the attachments on crowns, defines the application and function of a particular attachment.

Generally, after the software is used to model the placement of the attachment on a tooth crown for a particular movement, the practitioner can still adjust the size, the position, and orientation of the attachment on that tooth crown. Once the various parameters have been adjusted, a stereolithography (STL) model of the patient's arch with attachments may be created in which the attachment is reflected in the STL model. The STL model may then be formed, e.g., 3D printed, which will result in the attachment being built in the arch of the patient as well. Next, an aligner sheet may be thermoformed onto the 3D printed arch and wrapped around the arch including the body of the attachment by pressure. After thermoforming, the aligner may be trimmed and polished and thus the entire shape of aligner formed. The shape on the aligner for receiving the 3D printed attachment is called a receptacle.

To place the attachment on a tooth crown, the software may be used to first detect what movements are imparted to the tooth. There may be multiple movements programmed on the tooth simultaneously. The software may be used to determine for which movement the attachment will be placed, where the attachment will be placed on the tooth crown, what direction the active surface will be oriented by a protocol, which should have all the constraints that make the attachment feasible for 3D printing and thermoforming, including but not limited to margins to the occlusal, gingival, distal, and mesial sides, the maximal prominence on the crown.

An initial step may begin with an attachment being designed using the clinical experience of a practitioner. The shape, position, prominence, and orientation of the attachment may be generated by software, such as UDESIGN by uLab Systems, Inc. (San Mateo, Calif.), as described herein. These attachments may be automatically placed upon the crowns of specified teeth including the buccal/labial or lingual sides of teeth, occlusal surfaces, ridges on molars, incisal edges, facial axes for all crowns, etc.

A deep learning based artificial intelligence (AI) algorithm may be implemented to automatically find the features of the teeth. The major movement of the teeth of interest may be determined in terms of rotations and bodily movements imparted to the teeth. Given the stock attachments developed based on clinical experiences from doctors, the software may then be used to decide the appropriate attachments for each crown, if needed. The attachments may be placed in their respective positions utilizing the features of individual teeth. The software can also stage the treatment so certain movements occur before others on the same tooth allowing for the changing of attachments mid-treatment to effectively realize a different movement. For example, a sequence of movements may include a bodily move buccally, a rotation, then tipping movement of a tooth. Each of these movements may accordingly incorporate an attachment being secured and then removed to allow for the incorporation of a different attachment to the crown to impart a particular movement.

With the initial attachment design and placement completed, in the next step a physical resin model of the arch at a treatment stage of interest, e.g., stage-n, may be printed and mounted, e.g., on an electro-mechanical mounting system with force and torque sensors for each tooth model. The attachments may be printed upon the crowns or they may otherwise be bonded as separate attachments using any number of securement methods. The thermo-formed aligner may be fabricated for a subsequent treatment stage, e.g., stage n+1, and the aligner may be then engaged on the model arch. The forces and torques imparted on each tooth by the aligner may be measured by the force and torque sensors on the electro-mechanical mounting system and recorded.

The dental arch, including the teeth crown and mechanical linkage in the measurement system, may be modeled as a finite element model (FEM) used for finite element analysis (FEA) and the aligner may also be modeled as a FEM in the next step. The recorded forces and torque measurements may be applied accordingly to the teeth in the arch and aligner FEM. As part of the creation of the FEM, the thicknesses and other material properties may be applied to models of the bone and teeth. The measured forces and torques may be used to fine-tune the contact modeling between the aligner and crowns with attachments. As such the FEM will be calibrated by the measured force and torque.

In the next step, the measured forces on the FEM may be used to estimate the amount of movement and rotation of the teeth. This FEM can also be generated utilizing a cone beam computed tomography (CBCT) scan which can segment the alveolar bone and the teeth. Periodontic ligaments may also be modeled by connecting the bone to roots of the teeth within the FEM. Additionally, movement constraints and measured forces and torque may be applied to the FEM and analyzed. The output of the FEA may generate stresses and displacements and rotations imparted to the teeth. A combination of forces generated by the aligner and attachments can generate stress maps for each tooth at its root area and the corresponding stress map on the bone surrounding the root, which can be used to estimate the tooth movement for each tooth. This feedback may be used to change or alter the attachment design. By parameterizing the attachment design, different attachments can be measured for force and torque and fed to the FEM, which then generate the stress maps accordingly. Therefore, we can build a machine learning process with stress maps as the input and parameterized attachments on teeth as output.

The next step may include utilizing the stress map which was derived from intermediate scans on cases. The actual tooth movement as the result of the treatment can be captured by intra-oral scanning data which may be collected at clinics at each patient appointment. The characteristics of the cases and clinical movements measured by scan data may be used to build a machine learning process to predict the stress map required to achieve a defined tooth movement. The cases herein do not need to have attachments because the predictive relationship offered by this machine learning process is between the stress map on root-bone interface and the actual tooth movements.

From the comparison of the current tooth position and the previous tooth position, the tooth movement the tooth has gone through during the period lapsed between the two scans can be calculated. That tooth movement can be used to calculate the stress map on the root and the surrounding bones using the calibrated FEA. The learning algorithm may learn from case specific properties including, e.g., bone density, aligner material thickness, etc. along with stress maps and expected and achieved movements.

From the machine learning process that predicts the stress maps by tooth movements, we can obtain the stress maps that would be needed to achieve a particular movement. This stress maps will be fed to the machine learning process that can predict the attachment design by stress maps and therefore generate the attachment design. The software may automatically create properly scaled attachments with optimal size to achieve the expected movements. For instance, deep learning of clinical results may be used to generate improvements of the attachment sizing.

Turning now to specific embodiments of certain orthodontic attachments, these attachments may be designed and dimensioned utilizing the methods described herein. Particular attachments for securement upon particular teeth for performing specified movements or rotations will be described. Although particular measurements may be provided for each of the attachments, these are intended to be illustrative of possible dimensions and other dimension ranges may be utilized.

Moreover, for each of the attachments, sensitivity threshold levels and velocity treatment levels, which provide for the amount of movement per stage of treatment, may be provided. However, these threshold and velocity values may be customizable by the practitioner.

One method of optimizing an orthodontic attachment may generally comprise obtaining a digital model of a dentition of a subject, digitally placing one or more attachments upon the digital model for imparting one or more preselected movements to the dentition, forming a finite element model with one or more forces applied to the dentition, creating an initial stress map imparted upon the dentition based on the finite element model, and predicting a subsequent stress map to achieve the one or more preselected movements.

One embodiment of a system for correcting a malocclusion may generally comprise at least one attachment which is configured for securement upon a tooth, wherein the at least one attachment defines an active surface and one or more non-active surfaces which are separate and distinct from the active surface, and an aligner configured for placement over the tooth, wherein the aligner defines an attachment pocket sized to receive the at least one attachment within in a corresponding manner The attachment pocket may define a contact surface for contacting against the active surface of the at least one attachment such that contact against the active surface effectuates a movement of the tooth for correcting the malocclusion, and the attachment pocket further define a clearing space relative to the one or more non-active surfaces such that contact against the one or more non-active surfaces is inhibited.

### BRIEF DESCRIPTION OF THE DRAWINGS

FIG. 1A shows a flow chart of how an attachment may be created and formed depending upon the type of movement desired.

FIG. 1B shows a flow chart detailing the implementation of machine learning to predict stress maps which may be used to design the attachments for achieving the desired tooth movements.

FIG. 1C shows a perspective view of a patient's teeth having one or more attachments secured to a crown to effect a predetermined movement of that tooth and an aligner having a corresponding receiving channel.

FIG. 1D shows a perspective view of an example of an attachment positioned within a receiving channel of an aligner.

FIGS. 2A to 2E show multiple views of one variation of an attachment optimized for placement on central incisors and lateral incisors for extrusive or intrusive movements.

FIGS. 3A to 3E show multiple views of another variation of an attachment also optimized for placement on central incisors and lateral incisors for extrusive or intrusive movements but having filleted, rounded passive or non-active surfaces.

FIGS. 4A to 4E show multiple views of another variation of an attachment optimized for placement on central and lateral incisors for tipping movements.

FIGS. 5A to 5F show multiple views of another variation of an attachment optimized for placement on canines for extrusive and rotational movements, intrusive and rotational movements, and anchorage and rotational movements.

FIGS. 6A to 6F show multiple views of another variation of an attachment optimized for placement on canines for extrusive and rotational movements as well as intrusive and rotational movements.

FIGS. 7A to 7E show multiple views of another variation of an attachment optimized for placement on canines for rotational movements.

FIGS. 8A to 8E show multiple views of another variation of an attachment optimized for placement on molars for tipping movements.

FIGS. 9A to 9E show multiple views of another variation of an attachment optimized for placement on premolars and molars for anchorage.

FIGS. 10A to 10E show multiple views of another variation of an attachment optimized for placement on premolars and molars for anchorage but having filleted, rounded passive or non-active surfaces.

### DETAILED DESCRIPTION OF THE INVENTION

In designing an orthodontic attachment for use with an aligner in correcting for malocclusions, the orthodontic attachment may be initially designed utilizing the clinical experience of a practitioner such as an orthodontist and the attachment design may be subsequently optimized through machine learning. The various orthodontic attachments may be designed utilizing automated design software (e.g., UDESIGN, uLab Systems, Inc., Redwood City, Calif.) and forming processes such as those developed by uLab Systems, Inc. These software and forming processes which may be used with the attachments described herein are further described in U.S. Pat. Pubs. 2017/0100207; 2017/0100208; 2017/0100209; 2017/0100210; 2017/0100211; 2018/0078347; 2018/0078343; 2018/0078344; 2018/0078335; 2017/0100214, each of which is incorporated herein by reference in its entirety. The attachments described herein may also be used with any number of other teeth planning treatment systems such as those produced by Align Technologies, Inc. (San Jose, Calif.).

In many clear aligner cases, attachments may be used to increase the contact areas on one or more of the tooth crowns to augment the grip of an aligner upon the teeth of a patient. The shape and mechanics of the attachments that imparts the force and torque to the teeth, and the software algorithms that place the attachments on crowns, defines the application and function of a particular attachment.

As described herein, the intended contact area between the aligner and the orthodontic attachment is called an “active” surface and is a surface where the effective contact force is applied by the aligner upon the attachment and correspondingly to the tooth upon which the attachment is mounted. The “passive” or “non-active” surfaces of the orthodontic attachment are surfaces which are separate and distinct from the “active” surface and which does not come into contact against the aligner and which do not apply any (or a nominal) contact force which does not affect tooth movement. There may typically be a clearing space between the non-active surfaces and the aligner to ensure that the non-active surfaces do not make contact with the aligner. In this manner, the attachment pocket defined in the aligner which receives the attachment may have the same or similar shape to ensure contact between the active surface and the aligner while the non-active surface maintains the clearing space so as to prevent contact with the aligner.

In addition, based on the intended tooth movement, the intended contact area between the aligner and the particular tooth is called an “active aligner” surface and is a surface where the effective contact force is applied by the aligner upon the tooth. The “passive aligner” or “non-active aligner” surfaces of the aligner are surfaces which are separate and distinct from the “active aligner” surface and which is designed not come into contact against the attachment or tooth and which do not apply any (or a nominal) contact force which does not affect tooth movement. As described, there may typically be a clearing space between the non-active aligner surfaces of the aligner to ensure that the non-active aligner surfaces do not make contact with the tooth. In this manner, the aligner which may have the same or similar shape to ensure contact between the active aligner surface and the tooth while the non-active aligner surface maintains the clearing space so as to prevent contact with the tooth; coupling “active aligner” and “non active aligner” surface designs with their associated “active” and “non active” attachment surface designs ensure the required force is applied to the tooth effectively.

Generally, after the software is used to model the placement of the attachment on a tooth crown for a particular movement, the practitioner can still adjust the size, the position, and orientation of the attachment on that tooth crown. Once the various parameters have been adjusted, a stereolithography (STL) model of the patient's arch with attachments may be created in which the attachment is reflected in the STL model. The STL model may then be formed, e.g., 3D printed, which will result in the attachment being built in the arch of the patient as well. Next, an aligner sheet may be thermoformed onto the 3D printed arch and wrapped around the arch including the body of the attachment by pressure. After thermoforming, the aligner may be trimmed and polished and thus the entire shape of aligner formed. The shape on the aligner for receiving the 3D printed attachment is called a receptacle.

To place the attachment on a tooth crown, the software may be used to first detect what movements are imparted to the tooth. There may be multiple movements programmed on the tooth simultaneously. The software may be used to determine for which movement the attachment will be placed, where the attachment will be placed on the tooth crown, what direction the active surface will be oriented by a protocol, which should have all the constraints that make the attachment feasible for 3D printing and thermoforming, including but not limited to margins to the occlusal, gingival, distal, and mesial sides, the maximal prominence on the crown.

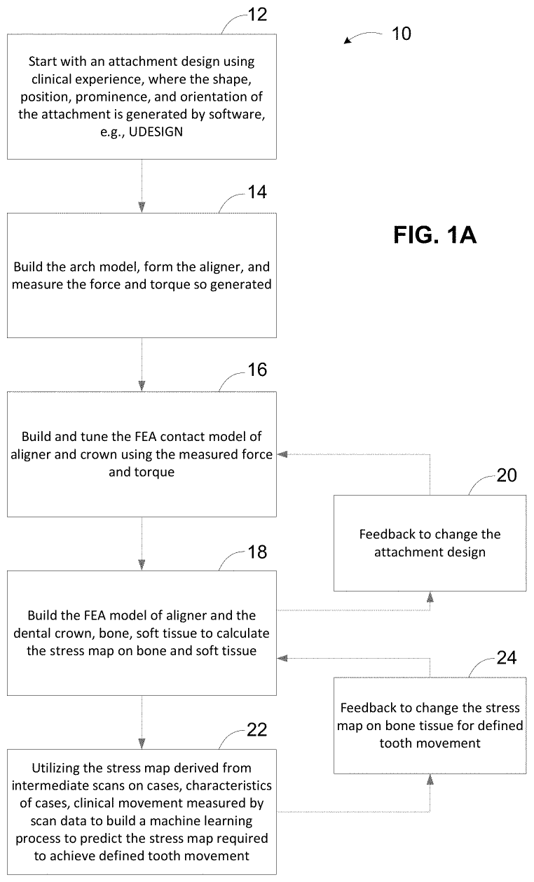

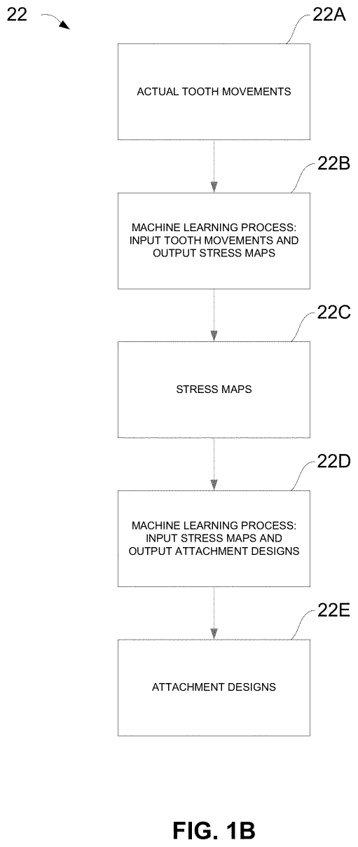

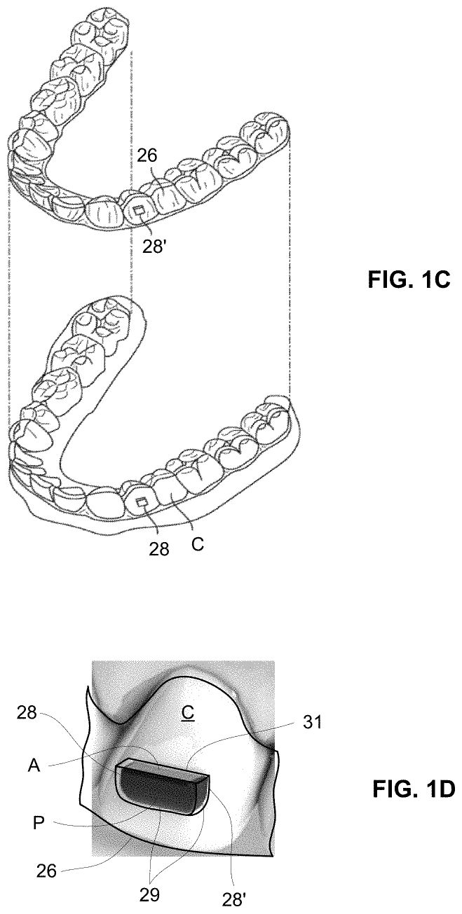

FIG. 1A shows a flow diagram 10 of one variation for how the attachments may be formed and optimized. An initial step 12 may begin with an attachment being designed using the clinical experience of a practitioner. The shape, position, prominence, and orientation of the attachment may be generated by software, such as UDESIGN by uLab Systems, Inc., as described herein. These attachments may be automatically placed upon the crowns of specified teeth including the buccal/labial or lingual sides of teeth, occlusal surfaces, ridges on molars, incisal edges, facial axes for all crowns, etc.

A deep learning based artificial intelligence (AI) algorithm may be implemented to automatically find the features of the teeth. The major movement of the teeth of interest may be determined in terms of rotations and bodily movements imparted to the teeth. Given the stock attachments developed based on clinical experiences from doctors, the software may then be used to decide the appropriate attachments for each crown, if needed. The attachments may be placed in their respective positions utilizing the features of individual teeth. The software can also stage the treatment so certain movements occur before others on the same tooth allowing for the changing of attachments mid-treatment to effectively realize a different movement. For example, a sequence of movements may include a bodily move buccally, a rotation, then tipping movement of a tooth. Each of these movements may accordingly incorporate an attachment being secured and then removed to allow for the incorporation of a different attachment to the crown to impart a particular movement.

With the initial attachment design and placement completed, in the next step 14 a physical resin model of the arch at a treatment stage of interest, e.g., stage-n, may be printed and mounted, e.g., on an electro-mechanical mounting system with force and torque sensors for each tooth model. The attachments may be printed upon the crowns or they may otherwise be bonded as separate attachments using any number of securement methods. The thermo-formed aligner may be fabricated for a subsequent treatment stage, e.g., stage n+1, and the aligner may be then engaged on the model arch. The forces and torques imparted on each tooth by the aligner may be measured by the force and torque sensors on the electro-mechanical mounting system and recorded.

The dental arch, including the teeth crown and mechanical linkage in the measurement system, may be modeled as a finite element model (FEM) used for finite element analysis (FEA) and the aligner may also be modeled as a FEM in the next step 16. The recorded forces and torque measurements may be applied accordingly to the active surfaces of the modeled attachments positioned on the teeth in the arch and aligner FEM. As part of the creation of the FEM, the thicknesses and other material properties may be applied to models of the bone and teeth. The measured forces and torques may be used to fine-tune the contact modeling between the aligner and crowns with attachments.

In the next step 18, the measured forces on the FEM may be used to estimate the amount of movement and rotation of the teeth. This 1-BM can also be generated utilizing a cone beam computed tomography (CBCT) scan which can segment the alveolar bone and the teeth. Periodontic ligaments may also be modeled by connecting the bone to roots of the teeth within the FEM. Additionally, movement constraints and measured forces on attachments may be applied to the FEM and analyzed. The output of the FEA may generate stresses and displacements and rotations imparted to the teeth. A combination of forces generated by the aligner and attachments can generate stress maps for each tooth at its root area and the corresponding stress map on the bone surrounding the root, which can be used to estimate the tooth movement for each tooth. This feedback may be used to change or alter 20 the attachment design in step 16 described above.

The next step 22 may include utilizing the stress map which was derived from intermediate scans on cases. The characteristics of the cases and clinical movements measured by scan data may be used to build a machine learning process to predict the stress map required to achieve a defined tooth movement. For instance, deep learning of clinical results may be used to generate improvements of the attachment sizing. The actual tooth movement as the result of the treatment with the attachments applied can be captured by intra-oral scanning data which may be collected at clinics at each patient appointment.

From the comparison of the current tooth position and the previous tooth position, the tooth movement the tooth has gone through during the period lapsed between the two scans can be calculated and provided as feedback 24. That tooth movement can be used to calculate the stress map on the root and the surrounding bones using FEA. By comparing the two stress maps from step 18 and step 22, a deep learning algorithm may be trained to minimize the difference between the two stress maps.

FIG. 1B illustrates a detailed process for step 22 in implementing the deep learning algorithm. With the actual desired tooth movements of the crowns and roots known 22A, as described above, along with other data pertaining to the patient such as age, gender, bone density, etc., this data can be input into the learning algorithm 22B to produce corresponding stress maps 22C. By using the FEA model schema to calculate the stress map, e.g., on alveolar bone, caused by loading of aligners with attachments, various parameters of the attachments may be altered. For instance, varying the prominence, draft angles, position, orientation of the attachment, etc. may yield variations in the corresponding stress maps due to these changes in attachment design and location. These derived predictive stress maps can then be used as an input into the learning algorithm 22D again to produce the corresponding attachment designs 22E.

Hence, with the tooth movements known, the corresponding stress maps may be developed which may then be used to create the predictive attachment designs to achieve the desired movements of the teeth.

Periodic scans may be taken and compared to the expected state of the tooth positions at that time. Because the amount of stresses and forces applied along with directions and achieved movement are known as well as the expected movements, machine learning may be utilized to get an amount of stress that would be needed to achieve a particular movement. The learning algorithm may learn from case specific properties including, e.g., bone density, aligner material thickness and such along with stress maps and expected and achieved movements. This information may be utilized and over time with deep learning, the software may automatically create properly scaled attachments with optimal size to achieve the expected movements.

Turning now to specific embodiments of certain orthodontic attachments, these attachments may be designed and dimensioned utilizing the methods described herein. Particular attachments for securement upon particular teeth for performing specified movements or rotations will be described. Although particular measurements may be provided for each of the attachments, these are intended to be illustrative of possible dimensions and other dimension ranges may be utilized.

Moreover, for each of the attachments, sensitivity threshold levels and velocity treatment levels, which provide for the amount of movement per stage of treatment, may be provided. However, these threshold and velocity values may be customizable by the practitioner.

As the attachments are secured to particular teeth, the aligner used may incorporate receiving channels or attachment pockets which are sized for receiving the attachment and preferentially interacting with the attachment to effect the desired movement. FIG. 1C shows a perspective view of an example of an aligner 26 having an attachment pocket 28′ defined at a predetermined location on the aligner 26. The attachment pocket 28′ defined in the aligner 26 which receives the attachment may have a similar shape but slightly enlarged to ensure contact between the active surface and the aligner 26 while the passive or non-active surfaces maintain a clearing space so as to prevent contact with the aligner 26. The underlying dentition shows an example of an attachment 28 secured upon the crown C of a predetermined tooth.

FIG. 1D illustrates a detailed perspective view showing an example of the attachment 28 having an active surface A and passive or non-active surfaces P which are distinct from the active surface A. With the aligner 26 placed upon the dentition and the attachment 28 positioned within the corresponding attachment pocket 28′, a portion of the attachment pocket 28′ may define an active aligner surface or contact surface 31 (as described herein) which is configured to directly contact against the active surface A while a clearing space 29 (formed by the non-active aligner surfaces, as described herein) may be defined between the passive or non-active surfaces P of the attachment 28 and the inner surfaces of the attachment pocket 28′ so that contact with the passive or non-active surfaces P is avoided and movement of the tooth is effected only by contact of the contact surface 31 of the aligner 26 against the active surface A of the attachment 28.

Although the example illustrates a single attachment used with the aligner, any number of attachments may be used with an aligner and any of the attachments described herein may be used with the aligner so that contact between the active surfaces and the aligner is maintained while contact with the passive or non-active surfaces and the aligner is inhibited by a clearing space.

Anterior Extrusive and Intrusive Attachments

Central incisors and lateral incisors are generally considered difficult to be extruded for treatment because the crown is in a wedge shape tapering to the occlusal side. Adding a flat surface to the incisors can help the aligner to grip the crown and apply an extrusive force at the flat surface, which is the active surface. When the attachment is reversed, the flat surface will be the active surface for the aligner to apply an intrusive force on the central and lateral incisors.

For the anterior extrusion and intrusion attachment to work, the incisor may be programmed into the software for an extrusive or intrusive movement. The software may place the active surface of the attachment at the junction of the middle/incisal third of the clinical crown of the central or lateral incisor and the long axis of the tooth bisecting the attachment. The normal of the active surface will be along the extrusive or intrusive direction. For extrusions, the normal will point to the gingival and for intrusion, the opposite.

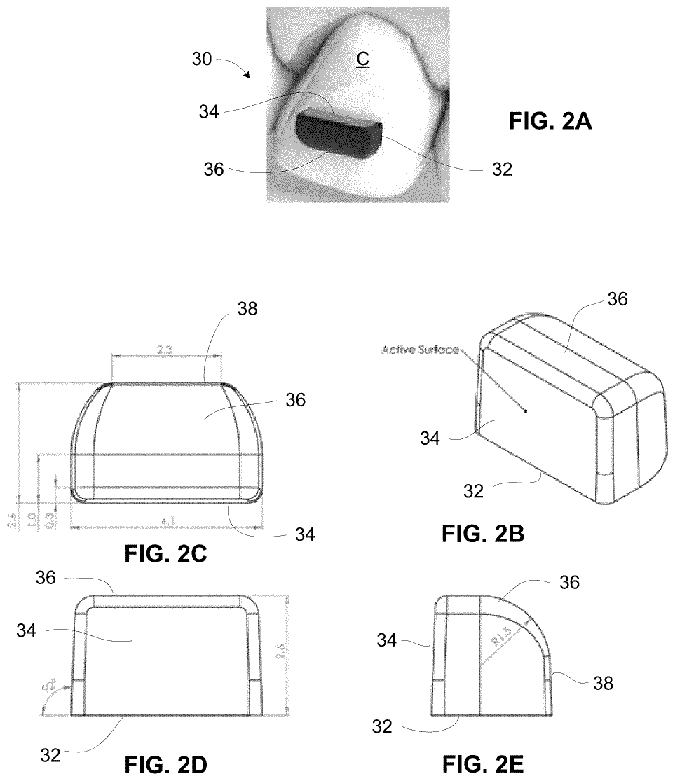

FIGS. 2A to 2E show various perspective and top, front, and side views of an attachment 30 for securement via an attachment surface 32 upon a crown C and may be used with a threshold movement of, e.g., 0.4 mm, and a velocity of 0.2 mm. The relatively large normal active surface 34 may be used for simple orthogonal movements with filleted edges for ease of aligner removal. For instance, the active surface 34 may taper along a curved surface, e.g., 92 degree angle side walls with a 1.5 mm radius, down to a reduced width of, e.g., 2.3 mm. The active surface 34 may present a relatively wide surface, e.g., 4.1 mm width and 2.6 mm height and 2.6 mm length, for better gripping of incisors and laterals. The passive or non-active surfaces 36 may present rounded surfaces on both axes for ease of aligner removal. Fillets on all edges may be present for ease of aligner removal.

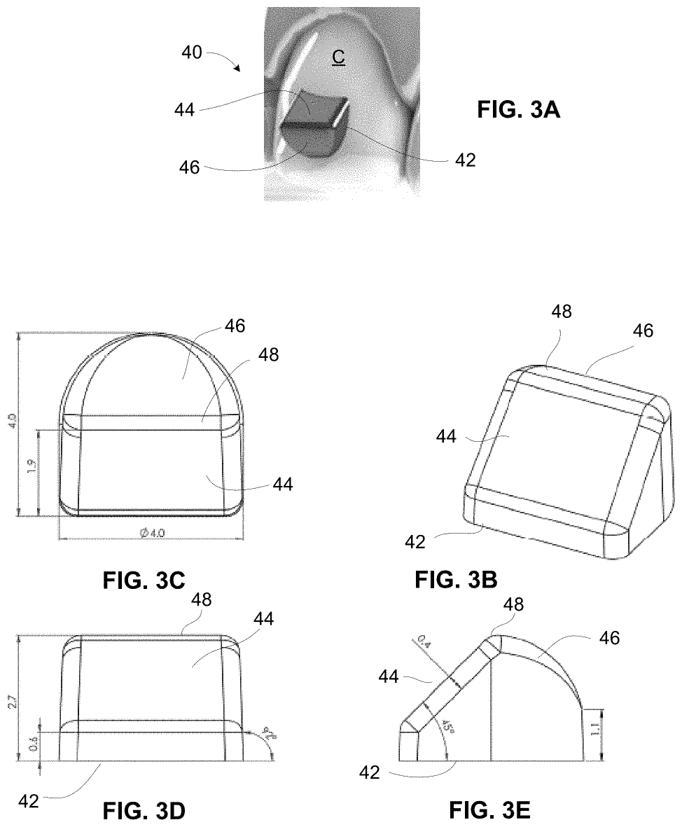

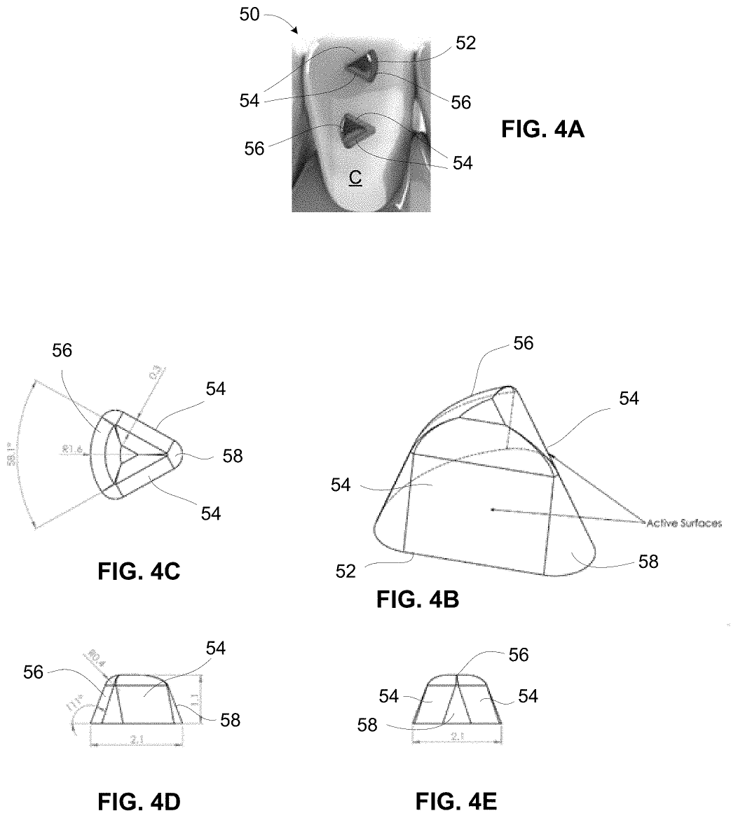

FIGS. 3A to 3E show various perspective and top, front, and side views of another variation of an attachment 40 for securement via an attachment surface 42 upon a crown C and may be used with a threshold movement of, e.g., 0.4 mm, and a velocity of, e.g., 0.2 mm. These attachments 40 may also be used for extrusive and intrusive movements of central and lateral incisors depending upon the direction of the active surface 44. The attachment 40 may be attached, e.g., at the junction of the middle/incisal third of the clinical crown, bisecting the long axis of the tooth. The attachment 40 is configured to have rounded and filleted a passive or non-active surface 46 angled relative to an active surface 44 to minimize protrusion from the crown C. The active surface 44 may be angled, e.g., 45 degrees, relative to the attachment surface 42 and meet the passive or non-active surface 46 along a vertex 48. Fillets, rounded passive or non-active surfaces, and an inward draft (e.g., 2 degrees relative to the normal angle, as shown in the front view of FIG. 3D, or 92 degrees relative to the attachment surface 42) facilitate easy aligner removal where the attachment 40 may have a length of, e.g., 4.0 mm, height of, e.g., 2.7 mm, and width of, e.g., 4.0 mm. The passive or non-active surface 46 may be rounded on both axes for ease of aligner removal and fillets on all edges may be presented for ease of aligner removal. The relatively large beveled active surface 44 may be presented for maximum efficiency in movement.

Anterior Tipping Attachments

Because both the buccal and lingual surfaces of the central and lateral incisors are relatively flat, it is generally difficult to impart a tipping force to the central and lateral incisors. One body attachment can provide some grip; however, the contact areas on a single body attachment are difficult to control due to the deformation of one contact area affecting another. Attachment 50 illustrates various perspective and top, side, and front views of another variation of an attachment 50 which may be used as a two-body design to form two receptacles for the attachment to the crown C along respective contact surfaces 52 where each will have its own contact areas and are structurally more stable and stronger.

A coupled pair attachment 50 may create a moment about the center of the lower incisor face to induce tipping of the incisor when secured along the incisal and middle thirds of the clinical crown, bisecting the long axis of the tooth and they may be used with a threshold movement of, e.g., 4 degrees, at a velocity of, e.g., 2 degrees. Each of the attachments 50 may have two angled active surfaces 54 having an angle of, e.g., 58.1 degrees, relative to one another, and which meet at a curved, filleted edge 58. A passive or non-active surface 56 may also be filleted to present a curved surface having a radius of, e.g., 1.6 mm, and which may be angled, e.g., 111 degrees, relative to the attachment surface 52. The attachment 50 may also have an overall width of, e.g., 2.1 mm, a length of, e.g., 2.1 mm, and a height of, e.g., 1.1 mm.

The force vectors for the moment may be self-correcting as per the symmetrical, angled geometry of the active surfaces 54 of the attachments 50 generating a self-correcting torque vector. By using the pointed edges 58 as the active surface, the attachments 50 may self-correct as one of the two active surfaces on each attachment 50 may counteract excess movement and bring the attachment 50 back to the desired path from their desired treatment path. The rounded passive or non-active surface 56 and filleted edges may be provided for ease of aligner removal.

In use, each of the attachment 50 may be positioned in opposing directions one on each side of the tipping center. The tipping center may first be calculated and the distance between the two attachments will be two third of the crown height and centered by the tipping center. The centroid of the two attachments may be along the long axis of tooth. If the crown is too small to fit the smallest attachment size feasible for 3D printing and thermoforming, another attachment type may be used instead.

Multiplanar Attachments

It is common to have multiple movements on the tooth crown which may be significant enough that multiple crowns need attachments to generate enough force and torque to realize the movements clinically. A variation of the attachment 60 may generate multiplanar movements by including more than one active surface 64 for the aligner receptacle to contact and apply force upon. The advantages of a multiplanar attachment 60 may include providing the mechanism to facilitate complex tooth movement, for example, extrusion and rotation, intrusion and rotation, and/or anchorage and rotation. The multiplanar attachment 60 also allow for self-correcting contact due to the multiple active surfaces designed to correct the off tracking of each other. Although, the multiplanar attachment 60 may be useful for complex movement on canine teeth, which are typically difficult to rotate due to its rounded shape, multiplanar attachments 60 can also be applied on any tooth crown.

The software may be used to determine if there is a combination of extrusion and rotation or intrusion and rotation that may benefit for the multiplanar attachment 60 and may orientate the combined vector of the multiple active surfaces along the directions of the combination of movements. The placement of the attachment 60 may be within the middle third of the clinical crown and the centroid of the attachment 60 may be on the long axis of the tooth and they may be used with a threshold movement of, e.g., 0.4 mm of extrusion, with a rotation of, e.g., 4 degrees, and a velocity of, e.g., 0.2 mm for extrusion/intrusion, with a velocity rotation of, e.g., 2 degrees.

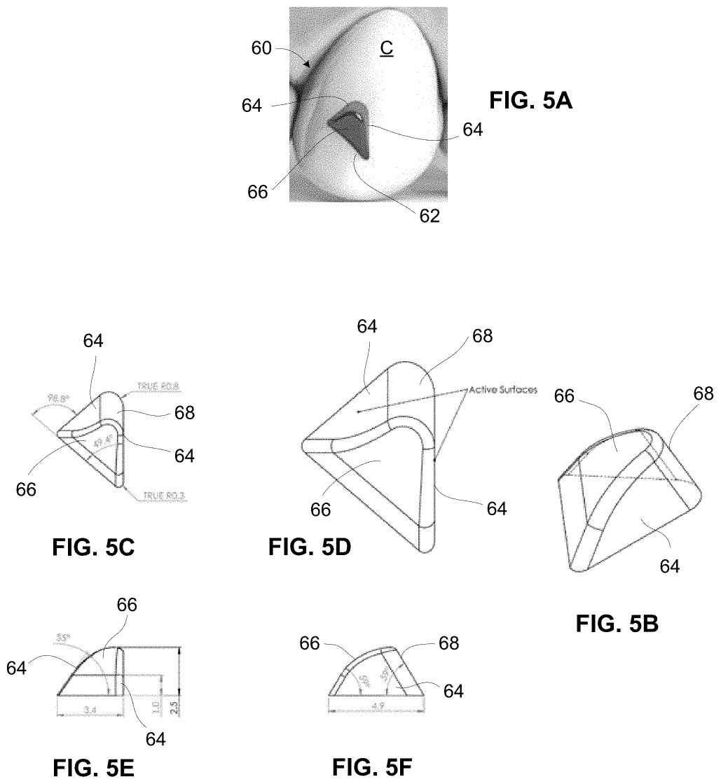

As shown in the perspective, top, end, and side views of FIGS. 5A to 5F, the attachment 60 is shown having a drafted orthogonal active surface 64 that leads to a passive or non-active surface 66 that tapers into the crown for ease of removal and to minimize breakage risk. The rounded passive or non-active surface 66 may have drafted sides and filleted edges for ease of aligner removal and the relatively large fillet 68 between the two active surfaces 64 may provide for maximum efficiency in rotation and either intrusion or extrusion depending upon the direction of the fillet 68 relative to the crown C. The active surfaces 64 of the attachment 60 may accordingly define an angle of, e.g., 98.8 degrees, when viewed from the top view of FIG. 5C and the fillet 68 may define an angle of, e.g., 59 degrees, when viewed from the side view of FIG. 5F. The attachment 60 may have an overall length of, e.g., 4.9 mm, width of, e.g., 3.4 mm, and a height of, e.g., 2.5 mm.

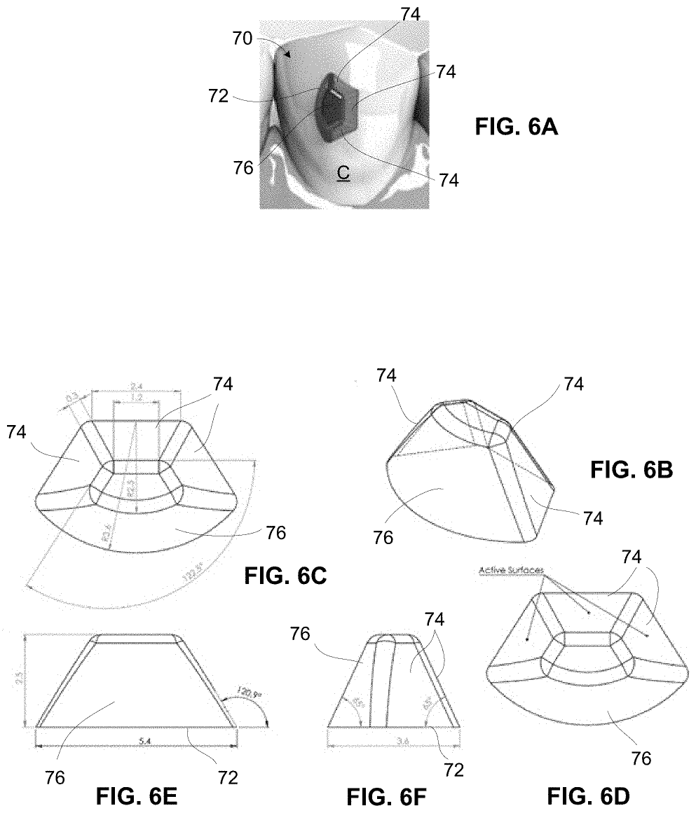

FIGS. 6A to 6F show perspective, top, front, and side views of another attachment 70 which may provide a relatively more angular multiplanar attachment 70 designed to grip and torque medial crowns rotationally. The attachments may be positioned on canine teeth to provide for a combinational movement of an extrusion and rotation, or intrusion and rotation when secured to the middle third of the clinical crown bisecting the long axis of the tooth.

The attachment 70 may provide for a rounded passive or non-active surface 76 with heavily drafted sides and filleted edges for ease of aligner removal and relatively large draft angles and active surfaces 74 which are symmetrical for a variety of placements and applications and which allow for relatively larger forces on the aligner and crowns. The filleted edges and drafted active surfaces 74 (e.g., defining an angle of 120.9 degrees relative to the attachment surface 72) may allow for ease of aligner removal and the rounded passive or non-active surface 76 with heavily drafted sides (e.g., defining an angle of 65 degrees relative to the attachment surface 72) and filleted edges may also allow for ease of aligner removal. The attachment may be used with a threshold movement of, e.g., 0.4 mm of extrusion or intrusion, with a velocity of, e.g., 0.2 mm.

The attachment may have an overall length of, e.g., 3.6 mm, width of, e.g., 5.4 mm, and height of, e.g., 2.5 mm. Additionally, the active surfaces 74 may have a width of, e.g., 1.2 mm, which taper to, e.g., 2.4 mm, as shown in FIG. 6C.

Rotational Attachments

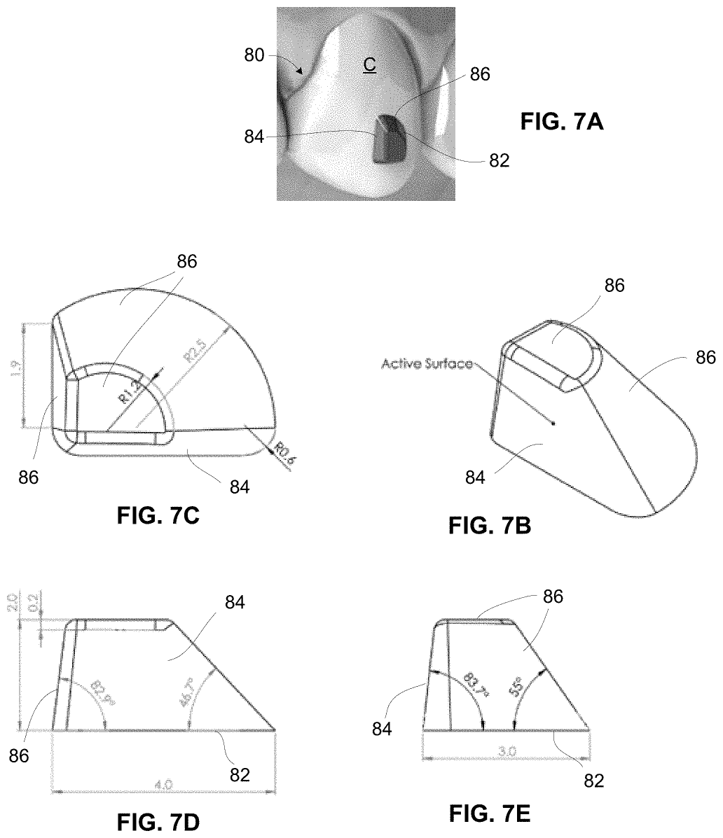

Canine rotation is generally a difficult movement without the aid of attachment, due to its rounded shape. A rotation attachment 80 may change the rounded shape by providing a sizable active surface 84 whose orientation can be adjusted to maximize the moment arm from the active surface to the long axis of the canine, as shown in the perspective, top, front, and side views of FIGS. 7A to 7E. Although, the multiplanar attachment 80 is useful for rotation on canine, it can be applied on any tooth crown. The attachment 80 may be positioned in the middle third of the clinical crown bisecting the long axis of the tooth to orientate the normal of the active surface 84 to maximize the moment arm from the centroid of the active surface 84 to the long axis of the tooth within all the constraints. The normal of the active surface 84 will point to the opposite direction of the rotation with a threshold of, e.g., 4 degrees of rotation, and a velocity of, e.g., 2 degrees.

As shown in the top and front views of FIGS. 7C and 7D, the attachment 80 may have a single, relatively large active surface 84 having a first angle of, e.g., 82.9 degrees, relative to the attachment surface 82 and a second angle of, e.g., 46.7 degrees, relative to the attachment surface 82. Moreover, the active surface 84 may be orthogonal to convert force into a pure rotation leading into a beveled passive or non-active surface 86. The attachment 80 may have a width of, e.g., 4.0 mm, a height of, e.g., 2.0 mm, and length of, e.g., 3.0 mm. Fillets and beveled passive or non-active surfaces 86 may allow for ease of aligner removal.

Posterior Tipping Attachments

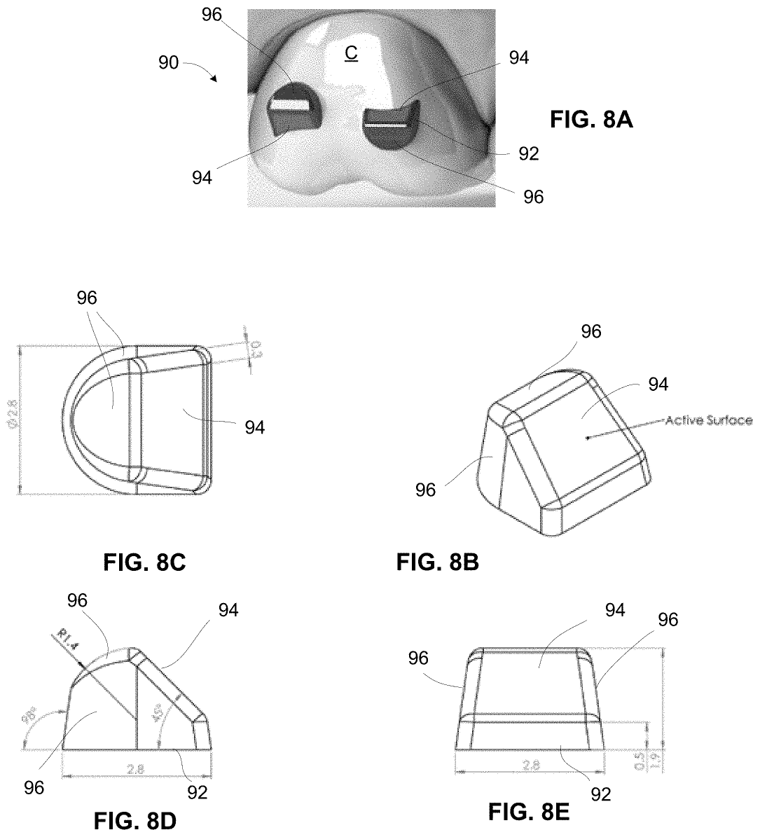

Tipping on posterior teeth such as the molars is generally made difficult because the buccal and lingual surfaces lack of contact area that an aligner can grip and also move due to their plural roots. The crowns of posterior teeth are generally larger than the crowns of anterior teeth allowing for the fitting of a pair of attachments 90 having their respective active surfaces 94 pointing in opposite directions relative to one another. This pair of attachments 90 may allow the aligner to apply a tipping moment when the crown C is programmed with a tipping movement and may be placed along the middle third of the clinical crown bisecting the long axis of the tooth and may be used with a threshold of, e.g., 4 degrees, and a velocity of, e.g., 2 degrees. The design of the posterior tipping attachment 90 can provide a relatively larger active surface 94 and larger tipping moment than an anterior tipping attachment to realize tipping on posterior teeth, as shown in the perspective, top, side, and front views of FIGS. 8A to 8E.

The attachments 90 may be may be used as a coupled pair to create a moment about a tipping center of the posterior crown C to induce tipping. The tipping center may be first calculated and the distance between the two attachments may be two third of the crown width and centered by the tipping center. The centroid of the two attachments may be along the long axis of tooth. The attachment 90 may be sized to have a length of, e.g., 2.8 mm, a width of, e.g., 2.8 mm, and a height of, e.g., 1.9 mm. If the crown C is too small to fit the smallest attachment size feasible for 3D printing and thermoforming, other attachment may be used instead.

The attachment 90 may be similar to the embodiment shown above in FIG. 3A, but this variation may be relatively smaller in dimension and used in pairs, as described. Moreover, the attachment 90 may also have a relatively larger draft in comparison, as shown in the front view of FIG. 8E, which shows a draft of, e.g., 8 degrees, relative to the normal angle or 98 degrees relative to the attachment surface 92.

Maximizing the surface area on small attachments allows for better grip and movement of obstinate molars. The passive or non-active surfaces 96 may be rounded on both axes for ease of aligner removal and fillets on all edges may also allow for ease of aligner removal. A relatively large beveled active surface 94, e.g., angled at 45 degrees relative to the attachment surface 92, may be provided for maximum efficiency in tipping movement.

Posterior Anchorage Attachments

As clear aligners work by applying force and torque onto the teeth, the reaction force and torque from the teeth onto the aligner can cause the posterior segment of the aligner to disengage from the posterior crowns, e.g., molars and premolars, under some circumstances. An anchorage attachment 100 may be designed to provide a relatively large active surface 104 to prevent the aligner from disengaging from the crown C thereby stabilizing the aligner. When an aligner has a tendency to lift up and off the crown C, the large active surface 104 may prevent or inhibit its disengagement and apply a force to keep the aligner down upon the crown C.

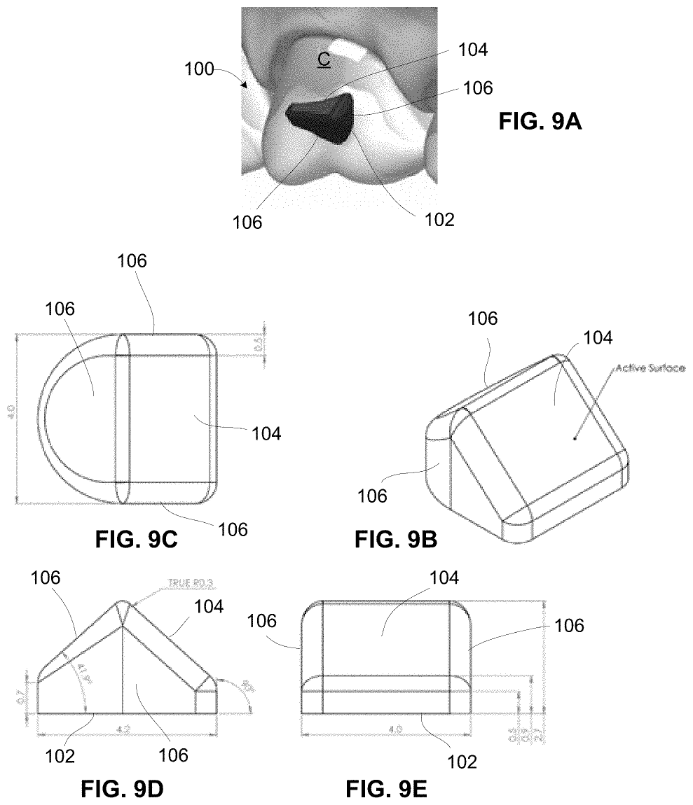

FIGS. 9A to 9E show perspective, top, side, and front views of an attachment 100 which may be placed along the middle third of the clinical crown and the long axis of the tooth bisecting the attachment. The beveled active surface 104 allows for this attachment 100 to operate bi-directionally and minimize material on the crown C. Filleted edges and beveled surfaces allow for ease of aligner removal and fillets on all edges allow for ease of aligner removal. FIG. 9D illustrates how the active surface 104 and passive or non-active surface 106 may be both angled, e.g., 41.9 degrees relative to the attachment surface 102 while the top view of FIG. 9C illustrates how the posterior portion of the passive or non-active surface 106 may be fully curved or arcuate. The attachment may have a width of, e.g., 4.0 mm, length of, e.g., 4.2 mm, and a height of, e.g., 2.7 mm.

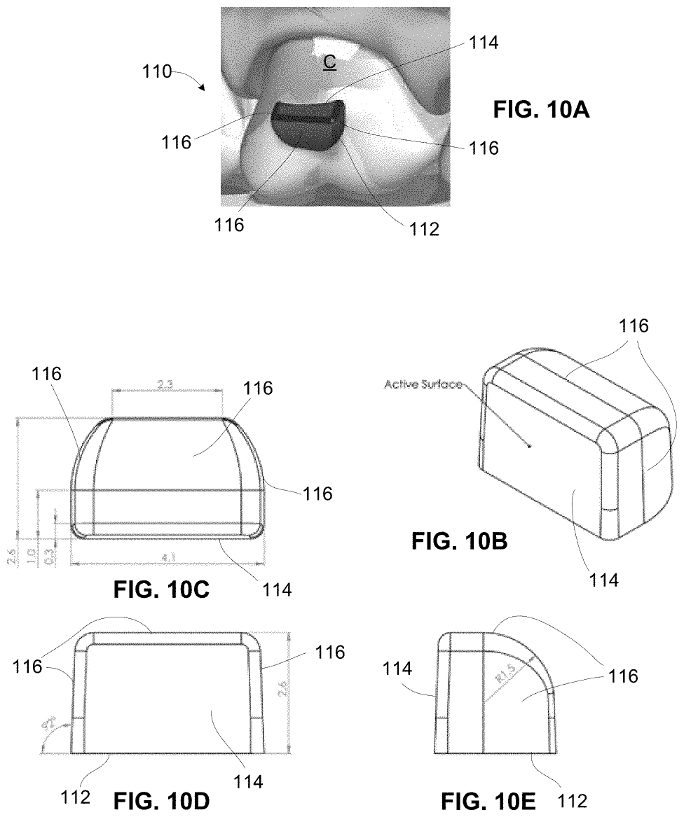

Similar to posterior anchorage attachment shown in FIGS. 9A to 9E, another embodiment is shown in the perspective, top, front, and side views of FIGS. 10A to 10E. The anchoring attachment 110 may be used to similarly provide for anchorage of the aligner relative to the posterior crowns, e.g., premolars and molars, and may be attached along the middle third of the clinical crown bisecting the long axis of the tooth. Although the passive or non-active surfaces 116 are filleted and rounded to allow for easier removal of aligner, they may be rounded on both axes for ease of aligner removal. Fillets on all edges may provide for ease of aligner removal and the large beveled active surface 114 may provide for maximum efficiency in movement and grip. The attachment 110 may have a width of, e.g., 4.1 mm, a length of, e.g., 2.6 mm, and a height of, e.g., 2.6 mm.

Any of the attachments described may be used in any number of different combinations with one another in a single or multiple treatments. Moreover, the various combination of attachments may be used with a single aligner or different aligners over the course of a treatment to impart the various movements and rotations to the teeth.

The applications of the devices and methods discussed above are not limited to the one described but may include any number of further treatment applications. Modification of the above-described assemblies and methods for carrying out the invention, combinations between different variations as practicable, and variations of aspects of the invention that are obvious to those of skill in the art are intended to be within the scope of the claims.

What is claimed is:

1. A system for correcting a malocclusion, comprising:
at least one attachment which is configured for securement upon a tooth, wherein the at least one attachment defines an active surface and one or more non-active surfaces which are separate and distinct from the active surface;
an aligner configured for placement over the tooth, wherein the aligner defines an attachment pocket sized to receive the at least one attachment within in a corresponding manner,
wherein the attachment pocket defines a contact surface for contacting against the active surface of the at least one attachment such that contact against the active surface effectuates a movement of the tooth for correcting the malocclusion, and
wherein the attachment pocket further defines a clearing space relative to the one or more non-active surfaces such that contact against the one or more non-active surfaces is inhibited.

2. The system of claim 1 wherein the at least one attachment is configured to provide an extrusive or intrusive movement to the tooth when the contact surface is pressed against the active surface.

3. The system of claim 1 wherein the at least one attachment is configured to provide a tipping movement to the tooth when the contact surface is pressed against the active surface.

4. The system of claim 1 wherein the at least one attachment is configured to provide an extrusive and rotational movement to the tooth when the contact surface is pressed against the active surface.

5. The system of claim 1 wherein the at least one attachment is configured to provide an intrusive and rotational movement to the tooth when the contact surface is pressed against the active surface.

6. The system of claim 1 wherein the at least one attachment is configured to provide a rotational movement to the tooth when the contact surface is pressed against the active surface.

7. The system of claim 1 wherein the at least one attachment is configured to provide anchoring to the tooth when the contact surface is pressed against the active surface.

8. The system of claim 1 wherein the active surface defines a planar surface.

9. The system of claim 1 wherein the active surface defines a curved surface.

10. The system of claim 1 wherein the aligner defines at least one active aligner surface for contact against the active surface to effectuate the movement of the tooth.

11. The system of claim 10 wherein the aligner further defines one or more non-active aligner surfaces which define the clearing space.

12. A method of optimizing an orthodontic attachment, comprising:
obtaining a digital model of a dentition of a subject;
digitally placing one or more attachments upon the digital model for imparting one or more preselected movements to the dentition;
forming a finite element model with one or more forces applied to the dentition;
creating an initial stress map imparted upon the dentition based on the finite element model; and
predicting a subsequent stress map to achieve the one or more preselected movements.

13. The method of claim 12 further comprising forming a physical model based on the digital model and the one or more attachments prior to forming the finite element model.

14. The method of claim 13 further comprising forming an aligner for placement upon the physical model.

15. The method of claim 14 further comprising measuring the one or more forces imparted upon the physical model from the aligner.

16. The method of claim 12 wherein creating the initial stress map comprises calculating the stress map of bone and tissue of the dentition.

17. The method of claim 12 further comprising placing one or more attachments upon the dentition to impart the one or more preselected movements.

18. The method of claim 17 wherein placing one or more attachments comprises positioning at least one attachment upon an anterior crown to impart an extrusive or intrusive movement.

19. The method of claim 18 wherein placing one or more attachments comprises positioning at least one attachment upon an anterior and/or posterior crown to impart a tipping movement.

20. The method of claim 17 wherein placing one or more attachments comprises positioning at least one attachment upon a crown to impart an extrusion and rotation, intrusion and rotation, or anchorage and rotation.

21. The method of claim 17 wherein placing one or more attachments comprises positioning at least one attachment upon an anterior crown to impart a rotation.

22. The method of claim 17 wherein placing one or more attachments comprises positioning at least one attachment upon a posterior crown to impart an anchoring force.
